(19) United States
(12) Patent Application Publication
(10) Pub. No.: US 2014/0247878 A1
(43) Pub. Date: Sep. 4, 2014

(54) CROSS-LAYER MOTION VECTOR PREDICTION

(71) Applicants: Lidong Xu, Beijing (CN); Yi-Jen Chiu, San Jose, CA (US); Wenhao Zhang, Beijing (CN); Yu Han, Beijing (CN); Xiaoxia Cai, Beijing (CN); Zhipin Apple Deng, Beijing (CN)

(72) Inventors: Lidong Xu, Beijing (CN); Yi-Jen Chiu, San Jose, CA (US); Wenhao Zhang, Beijing (CN); Yu Han, Beijing (CN); Xiaoxia Cai, Beijing (CN); Zhipin Apple Deng, Beijing (CN)

(21) Appl. No.: 13/977,285

(22) PCT Filed: Sep. 21, 2012
(86) PCT No.: PCT/CN2012/081722

§ 371 Date: Jun. 28, 2013

(51) Int. Cl. H04N 19/51; H04N 19/187; H04N 19/33

(52) U.S. Cl. CPC H04N 19/00696; H04N 19/00436; H04N 19/00321
USPC 375/240.16

(57) ABSTRACT

Systems, apparatus and methods are described including operations for video coding including cross-layer motion vector prediction.

### BACKGROUND

A video encoder compresses video information so that more information can be sent over a given bandwidth. The compressed signal may then be transmitted to a receiver that decodes or decompresses the signal prior to display.

High Efficient Video Coding (HEVC) is a new video compression standard planned to be finalized by the end 2012. It is currently under development by the Joint Collaborative Team on Video Coding (JCT-VC) formed by ISO/IEC Moving Picture Experts Group (MPEG) and ITU-T Video Coding Experts Group (VCEG). The team will also standardize a Scalable Video Coding (SVC) extension of HEVC standard.

As the standardization of the main part of HEVC is reaching completion, JCT-VC has started planning to add a Scalable Video Coding (SVC) extension into HEVC standard. SVC is an important issue to cope with the heterogeneity of networks and devices in modern video service environment. An SVC bit stream contains several subset bit streams that can themselves be decoded, and these sub streams represent the source video content with different resolution, frame rate, quality, bit depth, and etc. The scalabilities are achieved by using a multi-layer coding structure. In general, there is typically one base layer and several enhancement layers in an SVC system.

An SVC bitstream typically contains one base layer bitstream and at least one enhancement layer bitstream. The base layer bitstream can be decoded independently to reconstruct a base layer video. The enhancement layer bitstream may not be decoded independently, because the enhancement layer frames may be coded with prediction from lower layers, which is called cross-layer prediction or inter-layer prediction. The lower layer may be base layer or lower enhancement layer. Therefore, an enhancement layer bitstream may be decoded together with the lower layer data to construct the output video.

If a block in an enhancement layer picture is coded with inter prediction, a motion vector (MV) and reference index may be coded for the motion compensation at the decoder side. Generally, the MV of a block may be similar to the MVs of its spatial and temporal neighboring blocks. Therefore, for current block MV encoding, a predicted MV may be generated from neighboring block MVs, and then the MV difference (MVD) may be encoded, between the current block MV and the predicted MV. In H.264/AVC and previous H.264 based SVC standards, the predicted MV may be generated by media filtering the MVs from three spatial neighboring blocks, e.g., left, top, and top-right (or top-left if top-right is not available) neighbor blocks. In the latest HEVC coding standard, an MV candidate list may be generated first from spatial and temporal neighboring blocks, then the encoder may decide which candidate is the best for predicting current block MV and explicitly transmit the index of the best candidate to decoder. At the decoder side, the decoder may build the same candidate list from neighboring decoded block MVs, and then get the best candidate with the index decoded from the bitstream. If the best candidate is good enough for current block coding, there may be no MVD needs to be coded. which is called “Merge” mode in HEVC standard and the candidate list is called “Merge candidate list”. Otherwise, MVD needs to be coded, which is called an “AMVP” (advanced MV prediction) mode and the candidate list is called “AMVP candidate list”.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example video coding system;

FIG. 2 is a flow chart illustrating an example video coding process;

FIG. 3 is an illustrative diagram of an example video coding process in operation;

FIG. 4 is an illustrative diagram of example cross-layer motion vector prediction scheme;

FIG. 5 is an illustrative diagram of an example video coding system;

FIG. 6 is an illustrative diagram of an example system; and

FIG. 7 is an illustrative diagram of an example system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media, optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein. Additionally, any feature, structure, aspect, element, or characteristic from an embodiment can be combined with any feature, structure, aspect, element, or characteristic of any other embodiment whether or not explicitly described herein.

Systems, apparatus, articles, and methods are described below including operations for video coding including cross-layer motion vector prediction.

As described above, if a block in an enhancement layer picture is coded with inter prediction, a motion vector (MV) and reference index may be coded for the motion compensation at the decoder side. Generally, the MV of a block may be similar to the MVs of its spatial and temporal neighboring blocks. Therefore, for current block MV encoding, a predicted MV may be generated from neighboring block MVs. In H.264/AVC and previous H.264 based SVC standards, the predicted MV may be generated by media filtering the MVs from three spatial neighboring blocks, e.g., left, top, and top-right (or top-left if top-right is not available) neighbor blocks. In the latest HEVC coding standard, an MV candidate list may be generated first from spatial and temporal neighboring blocks, then the encoder may decide which candidate is the best for predicting current block MV and explicitly transmit the index of the best candidate to decoder. Generally, if the MV of current coding block is my and its predicted MV is pmv, then the MV difference, called MVD, between my and pmv is encoded into bitstream. In MPEG2, the pmv is obtained using the MV of left neighboring block. In H.264/AVC, pmv is obtained by median filtering the MVs of left, top and top-right spatial neighboring blocks. In HEVC, two MV prediction modes, e.g. AMVP mode and MERGE mode, are used. In AMVP mode, a two-entry AMVP candidate list is first constructed with three MVs from left spatial neighbor block, top spatial neighbor block, and collocated temporal neighbor block, respectively. Then the encoder decides to use which candidate to predict the current block MV and then encode the candidate index as well as the MVD into bitstream. In MERGE mode, an up-to five-entry MERGE candidate list is first constructed with four (MV, RefIdx) pairs from spatial neighbor blocks and one (MV, RefIdx) pair from temporal bottom-right or collocated neighbor block, where RefIdx is the index of the reference picture that the MV pointed to. After that, the encoder decides to use which candidate (MV, RefIdx) pair to encode current block and then encode the candidate index into bitstream. In MERGE mode, the selected (MV, RefIdx) pair is directly used to encode current block, and no MVD information needs to be coded. The number of merge candidates could be configured at encoder, with up to five merge candidates.

However, as will be described in greater detail below, in the next generation SVC standard is HEVC based SVC standard, e.g., the base layer might be compatible with the HEVC specification. Enhancement layer coding techniques may be used to predict the MV of an enhancement layer block from the MVs of not only the spatial and temporal neighboring blocks, but also the lower layer blocks via cross-layer motion vector prediction. In traditional video coding standards, only spatial and temporal neighbor block MVs were used to predict the MV of current block. Conversely, the methods discussed below apply cross-layer (e.g. inter-layer) MV prediction for the next generation SVC enhancement layer block coding, e.g., use of MVs of lower layer blocks to predict the MV of an enhancement layer block.

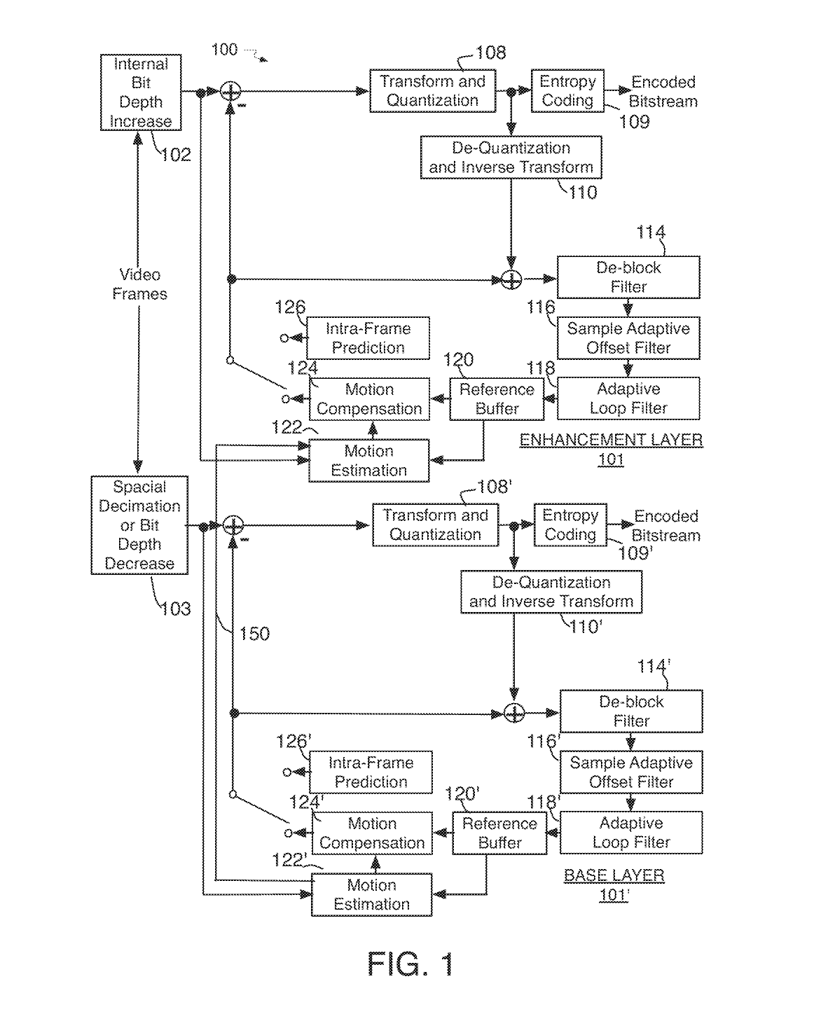

FIG. 1 is an illustrative diagram of an example video coding system 100, arranged in accordance with at least some implementations of the present disclosure. In various implementations, video coding system 100 may be configured to undertake video coding and/or implement video codecs according to one or more advanced video codec standards, such as, for example, the High Efficiency Video Coding (HEVC, aka H.265) video compression standard being developed by the Joint Collaborative Team on Video Coding (JCT-VC) formed by ISO/IEC Moving Picture Experts Group (MPEG) and ITU-T Video Coding Experts Group (VCEG). Further, in various embodiments, video coding system 100 may be implemented as part of an image processor, video processor, and/or media processor and may undertake inter prediction, intra prediction, predictive coding, and/or residual prediction including residual prediction in accordance with the present disclosure.

As used herein, the term “coder” may refer to an encoder and/or a decoder. Similarly, as used herein, the term “coding” may refer to encoding via an encoder and/or decoding via a decoder.

In some examples, video coding system 100 may include additional items that have not been shown in FIG. 1 for the sake of clarity. For example, video coding system 100 may include a processor, a radio frequency-type (RF) transceiver, a display, and/or an antenna. Further, video coding system 100 may include additional items such as a speaker, a microphone, an accelerometer, memory, a router, network interface logic. etc. that have not been shown in FIG. 1 for the sake of clarity.

In some examples, video coding system 100 may perform SVC operations. For example, two spatial resolution layers (e.g., base layer 101′ and enhancement layer 101), are illustrated: however, any number of enhancement layers may be utilized in addition to base layer 101′. Base layer 101′ may be processed via an HEVC compatible encoder. Information associated with base layer (e.g., such as prediction mode, reconstructed pixel and so on) may be used for coding of enhancement layer 101.

For example, during the operation of video coding system 100 on enhancement layer 101, current video information may be provided to an internal bit depth increase module 102 in the form of a frame of video data and subjected to known video transform and quantization processes by a transform and quantization module 108. The output of transform and quantization module 108 may be provided to an entropy coding module 109 and to a de-quantization and inverse transform module 110. De-quantization and inverse transform module 110 may implement the inverse of the operations undertaken by transform and quantization module 108. Those skilled in the art may recognize that transform and quantization modules and de-quantization and inverse transform modules as described herein may employ scaling techniques. The output of de-quantization and inverse transform module 110 may be provided to a loop including a de-blocking filter 114, a sample adaptive offset filter 116, an adaptive loop filter 118, a buffer 120, a motion estimation module 122, a motion compensation module 124 and an intra-frame prediction module 126. As shown in FIG. 1, the output of either motion compensation module 124 or intra-frame prediction module 126 is both combined with the output of de-quantization and inverse transform module 110 as input to de-blocking filter 114.

For example, in video coding system 100, a current video frame may be provided to a motion estimation module 122. System 100 may process the current frame in units of image macroblocks in raster scan order. When video coding system 100 is operated in inter-prediction mode, motion estimation module 122 may generate a residual signal in response to the current video frame and a reference video frame. Motion compensation module 124 may then use the reference video frame and the residual signal provided by motion estimation module 122 to generate a predicted frame. The predicted frame may then be subtracted from the current frame and the result provided to transform and quantization module 108. The block may then be transformed (using a block transform) and quantized to generate a set of quantized transform coefficients which may be reordered and entropy coded by entropy coding module 109 to generate a portion of a compressed bitstream (e.g., a Network Abstraction Layer (NAL) bitstream) provided by video coding system 100. In various implementations, a bitstream provided by video coding system 100 may include entropy-encoded coefficients in addition to side information used to decode each block (e.g., prediction modes, quantization parameters, motion vector information, and so forth) and may be provided to other systems and/or devices as described herein for transmission or storage.

The output of transform and quantization module 108 may also be provided to de-quantization and inverse transform module 110. De-quantization and inverse transform module 110 may implement the inverse of the operations undertaken by transform and quantization module 108 and the output of de-quantization and inverse transform module 110 may be combined with the predicted frame to generate a reconstructed frame. When video coding system 100 is operated in intra-prediction mode, intra-frame prediction module 126 may use the reconstructed frame to undertake known intra prediction schemes that will not to be described in greater detail herein.

In general, a current frame may be partitioned for compression by system 100 by division into one or more slices of coding tree blocks (e.g., 64×64 luma samples with corresponding chroma samples). Each coding tree block may also be divided into coding units (CU) in quad-tree split scheme. Further, each leaf CU on the quad-tree may be divided into partition units (PU) for motion-compensated prediction. In various implementations in accordance with the present disclosure, CUs may have various sizes including, but not limited to 64×64, 32×32, 16×16, and 8×8, while for a 2N×2N CU, the corresponding PUs may also have various sizes including, but not limited to, 2N×2N, 2N×N, N×2N, N×N, 2N×0.5N, 2N×1.5N, 0.5N×2N, 1.5N×2N. It should be noted, however, that the foregoing are only example CU partition and PU partition shapes and sizes, the present disclosure not being limited to any particular CU partition and PU partition shapes and/or sizes. As used herein, the term “block” may refer to a CU, or to a PU of video data.

In various implementations, a slice may be designated as an I (Intra), P (Predicted), B (Bi-predicted), SP (Switching P), SI (Switching I) type slices, or the like. In general, a frame may include different slice types. Further, frames may be designated as either non-reference frames or as reference frames that may be used as references for inter-frame prediction. In P slices, temporal (rather than spatial) prediction may be undertaken by estimating motion between frames. In B slices, two motion vectors, representing two motion estimates per PU may be used for temporal prediction or motion estimation. In addition, motion may be estimated from multiple pictures occurring either in the past or in the future with regard to display order. In various implementations, motion may be estimated at the various CU or PU levels corresponding to the sizes mentioned above.

In various implementations, a distinct motion vector may be coded for each CU and PU. During motion estimation processing a range of CU shape candidates (e.g., 64×64, 32×32, 16×16 and 8×8) and PU shape candidates (e.g., 2N×2N, 2N×N, N×2N, N×N, 2N×0.5N, 2N×1.5N, 0.5N×2N, 1.5N×2N) may be searched, and a motion estimation scheme that utilizes cross-layer motion vector prediction may be implemented.

Similarly, during the operation of video coding system 100 on base layer 101′, current video information may be provided to a spatial decimation or bit depth decrease module 103 in the form of a frame of video data and then passed to a transform and quantization module 108′. Transform and quantization module 108′ may perform known video transform and quantization processes. The output of transform and quantization module 108′ may be provided to a de-quantization and inverse transform module 110′. De-quantization and inverse transform module 110′ may implement the inverse of the operations undertaken by transform and quantization module 108′ to provide output to a loop including a de-blocking filter 114′, a sample adaptive offset filter 116′, an adaptive loop filter 118′, a buffer 120′, a motion estimation module 122′, a motion compensation module 124′ and an intra-frame prediction module 126′. Those skilled in the art may recognize that transform and quantization modules and de-quantization and inverse transform modules as described herein may employ scaling techniques. As shown in FIG. 1, the output of either motion compensation module 124′ or intra-frame prediction module 126′ is both combined with the output of de-quantization and inverse transform module 110′ as input to de-blocking filter 114′. The output of motion estimation module 122′ (illustrated by arrow 150 in FIG. 1, showing a cross-layer motion vector prediction operation) may be fed back to motion estimation module 122 (e.g., motion estimation module 122 being utilized for processing of enhancement layer 101 as apposed to base layer 101′)

In operation, during decoding a two-layer SVC bitstream may be de-muxed into two separate bitstreams (e.g. base layer 101′ bitstream and enhancement layer 101 bitstream), for decoding. The base layer 101′ bitstream could be independently decoded to reconstruct the base layer output video. For HEVC-based SVC, the base layer 101′ bitstream could be decoded independently, while the enhancement layer 101 bitstream could not be independently decoded to reconstruct the output video. The enhancement layer 101 bitstream may be decoded together with the base layer reconstructed video, because inter-layer prediction may be used for the encoding of some enhancement layer blocks. The base layer 101′ reconstructed video may be processed before being applied for inter-layer prediction. Additional operations for picture up-sampled for spatial scalability, picture tone mapping for bit-depth scalability, de-interlacing for interlace-progressive scalability, or some other kind of processing may optionally be performed.

As will be described in greater detail below, the arrow 150 in FIG. 1 shows a cross-layer motion vector prediction operation. The decoded motion vector of base layer or lower enhancement layer 101′ blocks could be used to predict the motion vectors of a block of enhancement layer 101.

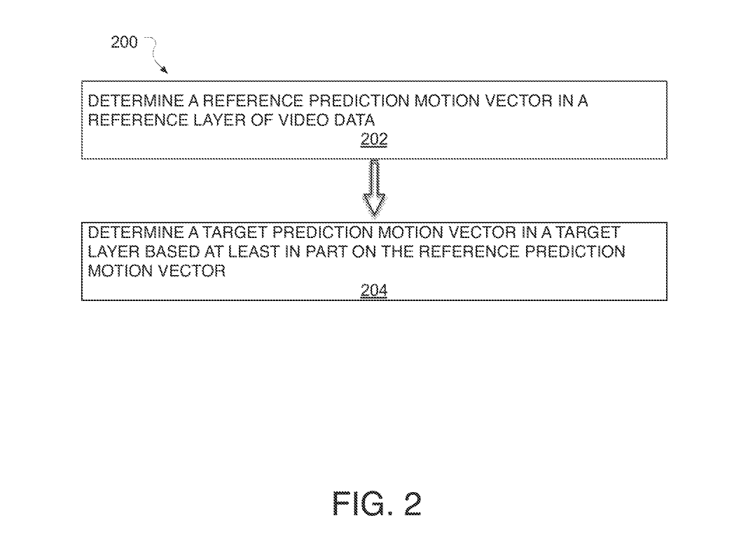

As will be discussed in greater detail below, video coding system 100 may be used to perform some or all of the various functions discussed below in connection with FIGS. 2 and/or 3.

FIG. 2 is a flow chart illustrating an example video coding process 200, arranged in accordance with at least some implementations of the present disclosure. In the illustrated implementation, process 200 may include one or more operations, functions or actions as illustrated by one or more of blocks 202 and/or 204. By way of non-limiting example, process 200 will be described herein with reference to example video coding system 100 of FIGS. 1 and/or 5.

Process 200 may be utilized as a computer-implemented method for cross-layer motion vector prediction. Process 200 may begin at block 202, “DETERMINE A REFERENCE PREDICTION MOTION VECTOR IN A REFERENCE LAYER OF VIDEO DATA”, where a reference prediction motion vector may be determined in a reference layer of video data. For example, the reference prediction motion vector may be determined in a reference layer of video data via a video coder.

Processing may continue from operation 202 to operation 204, “DETERMINE A TARGET PREDICTION MOTION VECTOR IN A TARGET LAYER BASED AT LEAST IN PART ON THE REFERENCE PREDICTION MOTION VECTOR”, where a target prediction motion vector may be determined in a target layer of video data. For example the target prediction motion vector may be determined in a target layer of video data based at least in part on the reference prediction motion vector via the video coder. Such a determination may be made via cross-layer motion vector prediction. In some examples, the target layer may be a higher layer than the reference layer.

In operation, the target layer may be a higher layer than the reference layer. For, example, when the reference layer includes a base layer, the target layer may include an enhancement layer; and when the reference layer includes an enhancement layer, the target layer may include a higher enhancement layer.

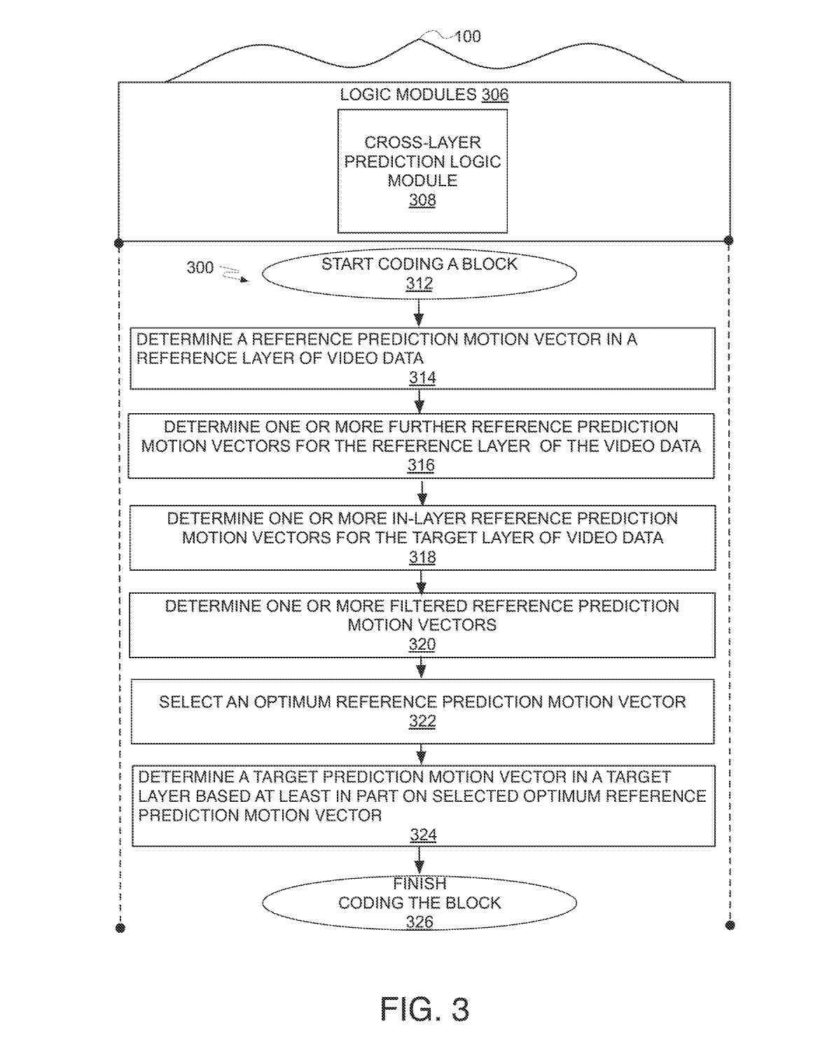

Some additional and/or alternative details related to process 200 may be illustrated in one or more examples of implementations discussed in greater detail below with regard to FIG. 3.

FIG. 3 is an illustrative diagram of example video coding system 1001 and video coding process 300 in operation, arranged in accordance with at least some implementations of the present disclosure. In the illustrated implementation, process 300 may include one or more operations, functions or actions as illustrated by one or more of actions 312, 314, 316, 318, 320. 322, 324, and/or 326. By way of non-limiting example, process 300 will be described herein with reference to example video coding system 100 of FIGS. 1 and/or 5.

In the illustrated implementation, video coding system 100 may include logic modules 306, the like, and/or combinations thereof. For example, logic modules 306, may include cross-layer motion vector prediction logic module 308, the like, and/or combinations thereof. Cross-layer motion vector prediction logic module 308 of video coding system 100 may be configured to determine a reference prediction motion vector in a reference layer of video data, and determine a target prediction motion vector in a target layer based at least in part on the reference prediction motion vector via cross-layer motion vector prediction. The target layer may be a higher layer than the reference layer. Although video coding system 100, as shown in FIG. 3, may include one particular set of blocks or actions associated with particular modules, these blocks or actions may be associated with different modules than the particular module illustrated here.

Process 300 may be utilized as a computer-implemented method for cross-layer motion vector prediction. Process 300 may begin at block 312. “START CODING A BLOCK”, and proceed to operation 314, “DETERMINE A REFERENCE PREDICTION MOTION VECTOR IN A REFERENCE LAYER OF VIDEO DATA”, where a reference prediction motion vector may be determined in a reference layer of video data. For example, the reference prediction motion vector may be determined in a reference layer of video data via a video coder.

In some examples, the target layer may be a higher layer than the reference layer. For, example, when the reference layer includes a base layer, the target layer may include an enhancement layer; and when the reference layer includes an enhancement layer, the target layer may include a higher enhancement layer.

Processing may continue from operation 316 to operation 318, “DETERMINE ONE OR MORE FURTHER REFERENCE PREDICTION MOTION VECTORS FOR THE REFERENCE LAYER OF THE VIDEO DATA”, where one or more further reference prediction motion vectors may be determined for the reference layer of the video data. For example, the one or more further reference prediction motion vectors may be determined for the reference layer of the video data via the video coder.

In some implementations, the one or more further reference prediction motion vectors and the reference prediction motion vector may include two or more of a cross-layer spatial neighbor, a coded cross-layer earlier temporal neighbor in display order, and a coded cross-layer later temporal neighbor in display order.

Additionally or alternatively, in some examples, the one or more further reference prediction motion vectors and the reference prediction motion vector may include scaled motion vectors. In some cases, the reference prediction motion vectors may be scaled before being applied to a target prediction motion. For example, scaling the reference prediction motion vectors based on the distance between the picture and its reference picture, and if spatial scalability, the base/lower layer reference prediction motion vectors may be scaled based on the ratio between enhancement layer picture size and base/lower layer picture size.

Processing may continue from operation 316 to operation 318, “DETERMINE ONE OR MORE IN-LAYER REFERENCE PREDICTION MOTION VECTORS FOR THE TARGET LAYER OF VIDEO DATA”, where one or more in-layer reference prediction motion vectors may be determined for the target layer of the video data. For example, the one or more in-layer reference prediction motion vectors may be determined for the target layer of the video data via the video coder.

In some implementations, the one or more in-layer reference prediction motion vectors may include one or more of an coded in-layer spatial neighbor, an coded in-layer earlier temporal neighbor in display order, and an coded in-layer later temporal neighbor in display order.

Processing may continue from operation 318 and/or operation 316 to operation 320, “DETERMINE ONE OR MORE FILTERED REFERENCE PREDICTION MOTION VECTORS”, where one or more filtered reference prediction motion vectors may be determined. For example, a filtration may be made, via the video coder, of the one or more further reference prediction motion vectors, the one or more in-layer reference prediction motion vectors, and/or the reference prediction motion vector to form one or more filtered reference prediction motion vectors.

In some implementations, the filtering may include one or more of the following operations: an averaging-type filter, a weighted averaging-type filter, a median-type filter, the like, and/or combinations thereof.

Processing may continue from operation 320, operation 316, and/or operation 318 to operation 322, “SELECT AN OPTIMUM REFERENCE PREDICTION MOTION VECTOR”, where an optimum reference prediction motion vector may be selected. For example, the optimum reference prediction motion vector may be selected, via the video coder, during coding based at least in part on a motion vector candidate list.

In some implementations, the motion vector candidate list may be associated with two or more of the following motion vectors: the reference prediction motion vector, the one or more further reference prediction motion vectors, the one or more in-layer reference prediction motion vectors, the scaled motion vectors, and the one or more filtered reference prediction motion vectors.

Processing may continue from any of operations 314-322 to operation 324 “DETERMINE A TARGET PREDICTION MOTION VECTOR IN A TARGET LAYER BASED AT LEAST IN PART ON SELECTED OPTIMUM REFERENCE PREDICTION MOTION VECTOR”, where a target prediction motion vector may be determined in a target layer of video data. For example the target prediction motion vector may be determined in a target layer of video data based at least in part on the selected optimum reference prediction motion vector via the video coder. Such a determination may be made via cross-layer motion vector prediction.

Processing may continue from operations 324 to operation 326 “FINISH CODING THE BLOCK”, where the coding of the data block may be completed based at least in part on the target prediction motion vector.

In operation, process 300 (and/or process 200) may operate so that the determination of the target prediction motion vector may include a mechanism to improve SVC enhancement layer coding efficiency by improving the motion vector coding for enhancement layer blocks. Further, SVC enhancement layer motion vector (MV) coding may be improved by applying inter-layer MV prediction (e.g. predict an MV of an enhancement layer block from the MVs of lower layer blocks). Here, the lower layer blocks could be the blocks in the lower layer picture captured at the same time with the current enhancement layer picture, or in the lower layer pictures captured at different time with the current enhancement layer picture. In some examples, SVC enhancement layer MV coding may be accomplished by applying only inter-layer MV prediction. In further examples, SVC enhancement layer MV coding may be accomplished by jointly applying spatial, temporal and/or cross-layer MV predictions. In still further examples, the MV of an enhancement layer block may be predicted from the MVs of lower layer blocks and/or from the scaled MVs of lower blocks. In other examples, the MV of an enhancement layer block may be predicted from the MV (or the scaled MV) of a specified lower layer block. In some examples, a filtered MV may be produced using the MVs (and/or scaled MVs) of multiple lower layer blocks, and then the filtered MV may be used to predict the MV of the enhancement layer block. In further examples, a filtered MV may be produced using the MVs (and/or scaled MVs) of multiple lower layer blocks, spatial neighboring block and/or temporal neighboring blocks, and then the filtered MV may be used to predict the MV of the enhancement layer block. In still further examples, an MV candidate list may be produced using the MVs (and/or scaled MVs) of multiple lower layer blocks, and then the encoder may decide the use of which candidate to predict the MV of the enhancement layer block and explicitly transmit the candidate index to decoder for MV decoding. Similarly, the decoder can produce the same MV candidate list as the encoder does, and then gets the MV predictor using the received candidate index. In other examples, an MV candidate list may be produced using the MVs (and/or scaled MVs) of multiple lower layer blocks, spatial neighboring block and/or temporal neighboring blocks, and then the encoder may decide the use of which candidate to predict the MV of the enhancement layer block and explicitly transmit the candidate index to decoder for MV decoding. Similarly, the decoder can produce the same MV candidate list as the encoder does, and then gets the MV predictor using the received candidate index.

While implementation of example processes 200 and 300, as illustrated in FIGS. 2 and 3, may include the undertaking of all blocks shown in the order illustrated, the present disclosure is not limited in this regard and, in various examples, implementation of processes 200 and 300 may include the undertaking only a subset of the blocks shown and/or in a different order than illustrated.

In addition, any one or more of the blocks of FIGS. 2 and 3 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIGS. 2 and 3 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

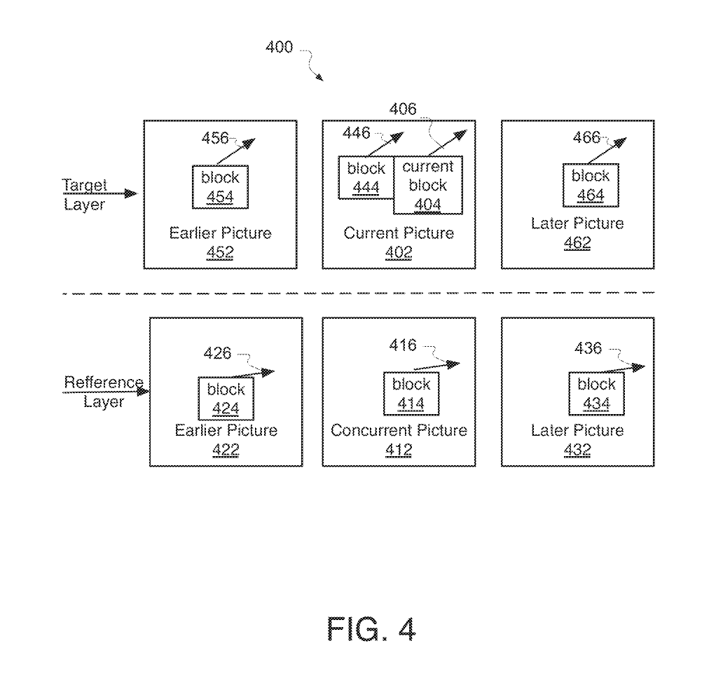

FIG. 4 is an illustrative diagram of example cross-layer motion vector prediction scheme in accordance with at least some implementations of the present disclosure. In the illustrated implementation, system 100 of FIG. 1 may implement scheme 40). In scheme 400, when encoding a predicted motion vector (MV) 406 of a current block 404 in enhancement layer current picture 402, multiple MVs from spatial, temporal and cross-layer (e.g., inter-layer) neighbor blocks could be used to generate the predicted MV 406, as shown in FIG. 2. Where, f_{B}(t) stands for a base layer picture 412 (e.g., concurrent picture 412) at time t, f_{E}(t) stands for an enhancement layer picture 402 (e.g., current picture 402) at time t, mv_{B}(t,x,y) stands for the MV 416 of a block 414 positioned at (x, y) in base layer picture f_{B}(t), and mv_{E}(t,x,y) stands for the MV 446 of a block 444 positioned at (x, y) in enhancement layer picture f_{E}(t).

As will be discussed in greater detail below, various MV candidates may be determined for enhancement layer MV prediction. Assuming current block 404 in current enhancement coding picture 402 f_{E}(t) is the current coding block positioned at (x_{c}, y_{c}) and the associated MV 406 obtained by motion estimation is mv_{E}(t,x_{c},y_{c}). f_{E}(t−m) is a coded enhancement layer picture 452 prior to current enhancement picture 402 in display order. f_{E}(t+n) is a coded enhancement layer picture 462 after current enhancement picture 402 in display order. f_{B}(t) is the base/lower picture 412 (e.g., concurrent picture 412) corresponding to current enhancement layer picture 402 f_{E}(t). f_{b}(t−m) is a coded base/lower layer picture 422 prior to current enhancement layer picture 402 f_{B}(t) in display order. f_{B}(t+n) is a coded base/lower layer picture 432 after current enhancement layer picture 402 f_{B}(t) in display order.

As will be described in greater detail below, the following listed MVs could be used to generate the predicted MV 406 for current block 404.

Spatial neighbor block 444 MVs 446 in current picture 402 f_{E}(t) may be represented by: mv_{E}(t,xₖ,yₖ,), where k=0, 1, . . . , K. In some embodiment, K could be zero, which means no spatial neighboring block MV will not be used.

Temporal neighbor block 454 MVs 456 from in-layer earlier picture 452 f_{E}(t−m) may be represented by: mv_{E}(t−m,xᵢ,yᵢ,), where m>0 and i==0, 1 . . . , I. In some embodiment, I could be zero, which means this kind of temporal neighboring block MV will not be used.

Temporal neighbor block 464 MVs 466 from in-layer later picture 462 f_{E}(t+n) may be represented by: mv_{E}(t+n,xⱼ,yⱼ,), where n>0 and j=0, 1, . . . , J. In some embodiment, J could be zero, which means this kind of temporal neighboring block MV will not be used.

Inter-layer neighbor block 414 MVs 416 from concurrent picture 412 f_{B}(t) may be represented by: mv_{B}(t,xₛ,yₛ,), where s=0, 1, . . . , S. In some embodiment, S could be zero, which means this kind of cross-layer neighboring block MV will not be used.

Temporal inter-layer block 424 MVs 426 from cross-layer earlier picture 422 f_{B}(t−m) may be represented by: mv_{B}(t−m,xₕ,yₕ,), where m>0 and h=0, 1 . . . , H. In some embodiment, H could be zero, which means this kind of temporal cross-layer neighboring block MV will not be used.

Temporal cross-layer block 434 MVs 436 from cross-layer later picture 432 f_{B}(t+n) may be represented by: mv_{B}(t+n,xₗ,yₗ,), where n>0 and l=0, 1, . . . , L. In some embodiment, L could be zero, which means this kind of temporal cross-layer neighboring block MV will not be used.

In some cases, the above listed MVs should be scaled before being applied to predict mv_{E}(t,x_{c},y_{c}). For example, scaling the MVs based on the distance between the picture and its reference picture, and if spatial scalability, the base/lower layer MVs may be scaled based on the ratio between enhancement layer picture size and base/lower layer picture size. Here we denote the scaled MVs of above listed MVs by mv′_{E}(t,xₖ,yₖ,), mv′_{E}(t−m,xᵢyᵢ,), mv′_{E}(t+n,xⱼ,yⱼ,), mv′_{B}(t,xₛ,yₛ,), mv′(t−m,xₕ,yₕ,), and mv′_{B}(t+n,xₗ,yₗ,).

As will be described in greater detail below, there are various cross-layer MV prediction schemes that may be applied to generate the predicted MV pmv_{E}(t,x_{c},y_{c},), using the possible candidates listed above, for the current enhancement layer block MV mv_{E}(t,x_{c},yₓ,). Here are some possible schemes:

1) Apply cross-layer MV prediction only, e.g., pmv_{E}(t,x_{c},y_{c},) is predicted from lower layer MVs and/or scaled lower layer MVs.

1.1) Use one of the lower layer MVs or scaled lower layer MVs to be the prediction pmv_{E}(t,x_{c},y_{c},). Which lower layer MVs is used may be described in the standard specification so that the encoder and decoder use the same one as was used in the prediction.

1.2) Use multiple lower layer MVs and/or scaled lower layer MVs to produce pmv_{E}(t,x_{c},y_{c},). With the multiple selected MVs from lower layers, the MV prediction pmv_{E}(t,x_{c},y_{c},) could be obtained by applying average filter, weighted average filter, median filter, or some other kind of filter on the selected MVs. Such filtering may be described in the standard specification (as to which lower layer MVs should be selected and what kind of filter should be applied) so that the encoder and decoder can produce the same MV prediction.

1.3) Build an MV candidate list with multiple lower MVs and or scaled lower layer MVs, and then let the encoder select a candidate as the MV prediction pmv_{E}(t,x_{c},y_{c},) and explicitly transmit the index of the selected candidate to decoder. Such operations may be described in the standard specification (regarding how to build the candidate list) so that the encoder and decoder can build the same candidate list.

1.4) In building the MV candidate list as said in 1.3, a candidate could also be a new MV obtained by applying average filter, weighted average filter, median filter, or some other kind of filter on multiple selected lower layer MVs and/or scaled lower layer MVs.

2) Jointly apply spatial, temporal and cross-layer MV predictions, e.g., pmv_{E}(t,x_{c},y_{c},) may be predicted from not only lower layer (scaled) MVs but also spatial and temporal neighboring (scaled) MVs.

2.1) Use multiple selected MVs and/or scaled MVs from spatial, temporal and lower layer blocks to produce pmv_{E}(t,x_{c},y_{c},). With the multiple selected MVs, the MV prediction pmv_{E}(t,x_{c},y_{c},) could be obtained by applying average filter, weighted average filter, median filter, or some other kind of filter on the selected MVs. Such operations may be described in standard specification (regarding which MVs should be selected and what kind of filter should be applied) so that the encoder and decoder can produce the same MV prediction.

2.2) Build an MV candidate list with multiple MVs and/or scaled MVs from spatial, temporal and lower layer blocks, and then let the encoder select a candidate as prediction pmv_{E}(t,x_{c},y_{c},) and explicitly transmit the index of the selected candidate to decoder. Such operations may be described in the standard specification (regarding how to build the candidate list) so that the encoder and decoder can build the same candidate list.

2.3) In building the MV candidate list as said in 2.2, a candidate could also be a new MV obtained by applying average filter, weighted average filter, median filter, or some other kind of filter on multiple selected MVs and/or scaled MVs of spatial, temporal and lower layer blocks.

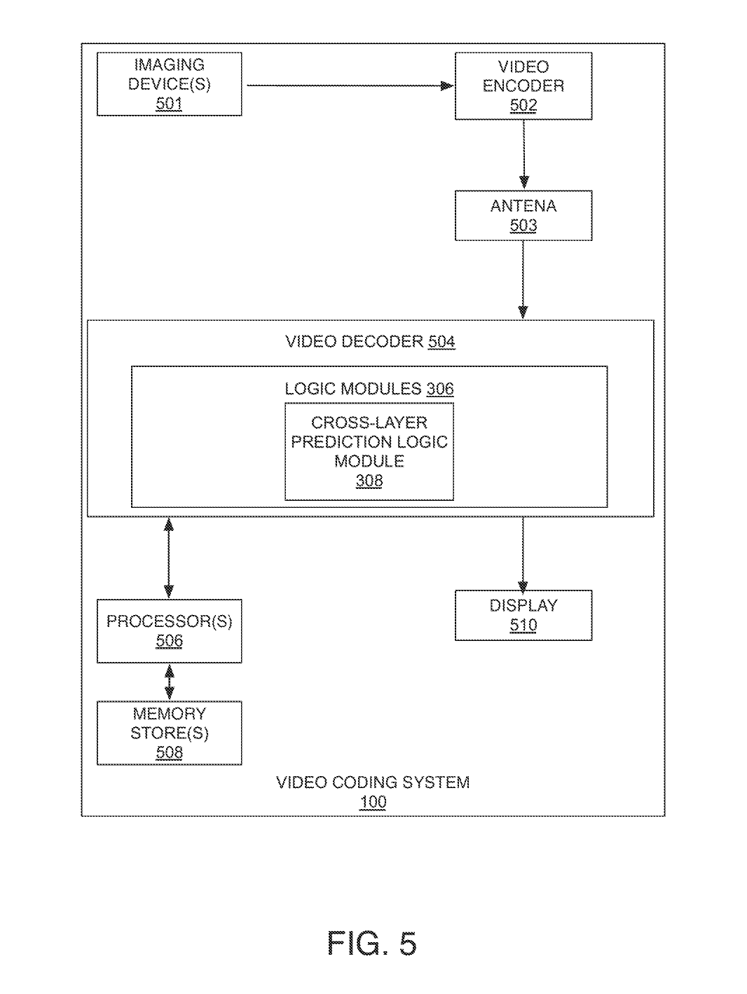

FIG. 5 is an illustrative diagram of an example video coding system 10 (, arranged in accordance with at least some implementations of the present disclosure. In the illustrated implementation, video coding system 100 may include imaging device(s) 501, a video encoder 502, an antenna 503, a video decoder 504, one or more processors 506, one or more memory stores 508, a display 510, and/or logic modules 306. Logic modules 306 may include cross-layer motion vector prediction logic module 308, the like, and/or combinations thereof.

As illustrated, antenna 503, video decoder 504, processor 506, memory store 508, and/or display 510 may be capable of communication with one another and/or communication with portions of logic modules 306. Similarly, imaging device(s) 501 and video encoder 502 may be capable of communication with one another and/or communication with portions of logic modules 306. Accordingly, video decoder 504 may include all or portions of logic modules 306, while video encoder 502 may include similar logic modules. Although video coding system 100, as shown in FIG. 5, may include one particular set of blocks or actions associated with particular modules, these blocks or actions may be associated with different modules than the particular module illustrated here.

In some examples, video coding system 100 may include antenna 503, video decoder 504, the like, and/or combinations thereof. Antenna 503 may be configured to receive an encoded bitstream of video data. Video decoder 504 may be communicatively coupled to antenna 503 and may be configured to decode the encoded bitstream. Video decoder 504 may be configured to determine a reference prediction motion vector in a reference layer of video data, and determine a target prediction motion vector in a target layer based at least in part on the reference prediction motion vector via cross-layer motion vector prediction, where the target layer is a higher layer than the reference layer.

In other examples, video coding system 100 may include display device 510, one or more processors 506, one or more memory stores 508, cross-layer motion vector prediction logic module 308, the like, and/or combinations thereof. Display 510 may be configured to present video data. Processors 506 may be communicatively coupled to display 510. Memory stores 508 may be communicatively coupled to the one or more processors 506. Cross-layer motion vector prediction logic module 308 of video decoder 504 (or video encoder 502 in other examples) may be communicatively coupled to the one or more processors 506 and may be configured to determine a reference prediction motion vector in a reference layer of video data, and determine a target prediction motion vector in a target layer based at least in part on the reference prediction motion vector via cross-layer motion vector prediction, where the target layer is a higher layer than the reference layer.

In various embodiments, cross-layer motion vector prediction logic module 308 may be implemented in hardware, while software may implement other logic modules. For example, in some embodiments, cross-layer motion vector prediction logic module 308 may be implemented by application-specific integrated circuit (ASIC) logic while other logic modules may be provided by software instructions executed by logic such as processors 506. However, the present disclosure is not limited in this regard and cross-layer motion vector prediction logic module 308 and/or other logic modules may be implemented by any combination of hardware, firmware and/or software. In addition, memory stores 508 may be any type of memory such as volatile memory (e.g. Static Random Access Memory (SRAM), Dynamic Random Access Memory (DRAM), etc.) or non-volatile memory (e.g., flash memory, etc.), and so forth. In a non-limiting example, memory stores 508 may be implemented by cache memory.

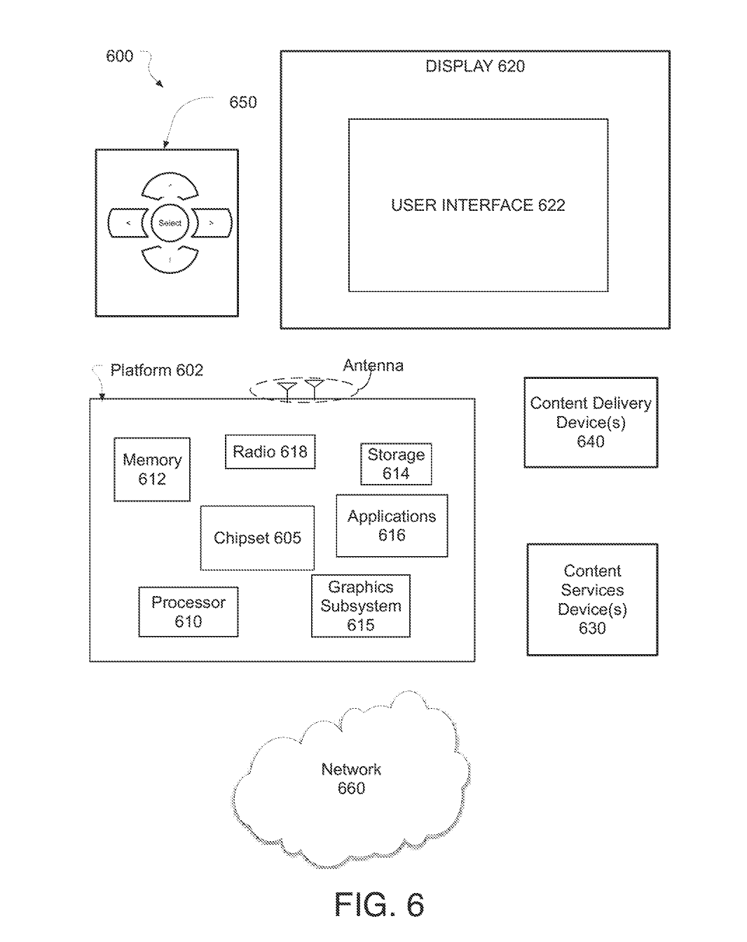

FIG. 6 illustrates an example system 600 in accordance with the present disclosure. In various implementations, system 600 may be a media system although system 600 is not limited to this context. For example, system 600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 600 includes a platform 602 coupled to a display 620. Platform 602 may receive content from a content device such as content services device(s) 630 or content delivery device(s) 640 or other similar content sources. A navigation controller 650 including one or more navigation features may be used to interact with, for example, platform 602 and/or display 620. Each of these components is described in greater detail below.

In various implementations, platform 602 may include any combination of a chipset 605, processor 610, memory 612, storage 614, graphics subsystem 615, applications 616 and/or radio 618. Chipset 605 may provide intercommunication among processor 610, memory 612, storage 614, graphics subsystem 615, applications 616 and/or radio 618. For example, chipset 605 may include a storage adapter (not depicted) capable of providing intercommunication with storage 614.

Processor 610 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 610 may be dual-core processor(s), dual-core mobile processor(s), and so forth.

Memory 612 may be implemented as a volatile memory device such as, but not limited to, a Random Access Memory (RAM). Dynamic Random Access Memory (DRAM), or Static RAM (SRAM).

Storage 614 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 614 may include technology to increase the storage performance enhanced protection for valuable digital media when multiple hard drives are included, for example.

Graphics subsystem 615 may perform processing of images such as still or video for display. Graphics subsystem 615 may be a graphics processing unit (GPU) or a visual processing unit (VPU), for example. An analog or digital interface may be used to communicatively couple graphics subsystem 615 and display 620. For example, the interface may be any of a High-Definition Multimedia Interface, Display Port, wireless HDMI, and/or wireless HD compliant techniques. Graphics subsystem 615 may be integrated into processor 610 or chipset 605. In some implementations, graphics subsystem 615 may be a stand-alone card communicatively coupled to chipset 605.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 618 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 618 may operate in accordance with one or more applicable standards in any version.

In various implementations, display 620 may include any television type monitor or display. Display 620 may include, for example, a computer display screen, touch screen display, video monitor, television-like device, and/or a television. Display 620 may be digital and/or analog. In various implementations, display 620 may be a holographic display. Also, display 620 may be a transparent surface that may receive a visual projection. Such projections may convey various forms of information, images, and/or objects. For example, such projections may be a visual overlay for a mobile augmented reality (MAR) application. Under the control of one or more software applications 616, platform 602 may display user interface 622 on display 620.

In various implementations, content services device(s) 630 may be hosted by any national, international and/or independent service and thus accessible to platform 602 via the Internet, for example. Content services device(s) 630 may be coupled to platform 602 and/or to display 620. Platform 602 and/or content services device(s) 630 may be coupled to a network 660 to communicate (e.g., send and/or receive) media information to and from network 660. Content delivery device(s) 640 also may be coupled to platform 602 and/or to display 620.

In various implementations, content services device(s) 630 may include a cable television box, personal computer, network, telephone, Internet enabled devices or appliance capable of delivering digital information and/or content, and any other similar device capable of unidirectionally or bidirectionally communicating content between content providers and platform 602 and/display 620, via network 660 or directly. It will be appreciated that the content may be communicated unidirectionally and/or bidirectionally to and from any one of the components in system 600 and a content provider via network 660. Examples of content may include any media information including, for example, video, music, medical and gaming information, and so forth.

Content services device(s) 630 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 602 may receive control signals from navigation controller 650 having one or more navigation features. The navigation features of controller 650 may be used to interact with user interface 622, for example. In embodiments, navigation controller 650 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 650 may be replicated on a display (e.g., display 620) by movements of a pointer, cursor, focus ring, or other visual indicators displayed on the display. For example, under the control of software applications 616, the navigation features located on navigation controller 650 may be mapped to virtual navigation features displayed on user interface 622, for example. In embodiments, controller 650 may not be a separate component but may be integrated into platform 602 and/or display 620. The present disclosure, however, is not limited to the elements or in the context shown or described herein.

In various implementations, drivers (not shown) may include technology to enable users to instantly turn on and off platform 602 like a television with the touch of a button after initial boot-up, when enabled, for example. Program logic may allow platform 602 to stream content to media adaptors or other content services device(s) 630 or content delivery device(s) 640 even when the platform is turned “off.” In addition, chipset 605 may include hardware and/or software support for surround sound audio and/or high definition (7.1) surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 600 may be integrated. For example, platform 602 and content services device(s) 630 may be integrated, or platform 602 and content delivery device(s) 640 may be integrated, or platform 602, content services device(s) 630, and content delivery device(s) 640 may be integrated, for example. In various embodiments, platform 602 and display 620 may be an integrated unit. Display 620 and content service device(s) 630 may be integrated, or display 620 and content delivery device(s) 640 may be integrated, for example. These examples are not meant to limit the present disclosure.

In various embodiments, system 600 may be implemented as a wireless system, a wired system, or a combination of both. When implemented as a wireless system, system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 602 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

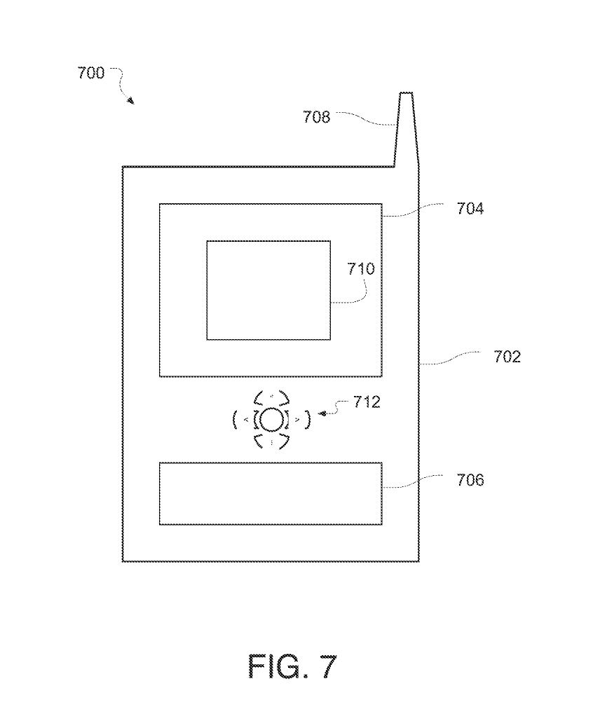

As described above, system 600 may be embodied in varying physical styles or form factors. FIG. 7 illustrates implementations of a small form factor device 700 in which system 600 may be embodied. In embodiments, for example, device 700 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 700 may include a housing 702, a display 704, an input/output (I/O) device 706, and an antenna 708. Device 700 also may include navigation features 712. Display 704 may include any suitable display unit for displaying information appropriate for a mobile computing device. I/O device 706 may include any suitable I/O device for entering information into a mobile computing device. Examples for I/O device 706 may include an alphanumeric keyboard, a numeric keypad, a touch pad, input keys, buttons, switches, rocker switches, microphones, speakers, voice recognition device and software, and so forth. Information also may be entered into device 700 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further embodiments.

In one example, a computer-implemented method for video coding may include determining, via a video coder, a reference prediction motion vector in a reference layer of video data. A determination may be made, via the video coder, of a target prediction motion vector in a target layer based at least in part on the reference prediction motion vector via cross-layer motion vector prediction, where the target layer is a higher layer than the reference layer.

In another example, a computer-implemented method for video coding may further include determining, via the video coder, one or more further reference prediction motion vectors for the reference layer of the video data. The one or more further reference prediction motion vectors and the reference prediction motion vector may include two or more of a cross-layer spatial neighbor, a coded cross-layer earlier temporal neighbor in display order, and a coded cross-layer later temporal neighbor in display order. The one or more further reference prediction motion vectors and the reference prediction motion vector may include scaled motion vectors. In cases where the reference layer includes a base layer, the target layer may include an enhancement layer. Similarly, in cases where the reference layer includes an enhancement layer, the target layer may include a higher enhancement layer. A determination may be made, via the video coder, of one or more in-layer reference prediction motion vectors for the target layer of the video data. The one or more in-layer reference prediction motion vectors may include one or more of an coded in-layer spatial neighbor, an coded in-layer earlier temporal neighbor in display order, and an coded in-layer later temporal neighbor in display order. A filtration may be made, via the video coder, of the one or more further reference prediction motion vectors, the one or more in-layer reference prediction motion vectors, and/or the reference prediction motion vector to form one or more filtered reference prediction motion vectors. The filtering may include one or more of the following operations: an averaging-type filter, a weighted averaging-type filter, a median-type filter, the like, and/or combinations thereof. A selection may be made, via the video coder, of an optimum reference prediction motion vector during coding based at least in part on a motion vector candidate list. The motion vector candidate list may be associated with two or more of the following motion vectors: the reference prediction motion vector, the one or more further reference prediction motion vectors, the one or more in-layer reference prediction motion vectors, the scaled motion vectors, and the one or more filtered reference prediction motion vectors. The determination, via the video coder, of the target prediction motion vector for the target layer may be based at least in part on the selected optimum reference prediction motion vector.

In other examples, a system for video coding on a computer may include a display device, one or more processors, one or more memory stores, a cross-layer motion vector prediction logic module, the like, and/or combinations thereof. The display device may be configured to present video data. The one or more processors may be communicatively coupled to the display device. The one or more memory stores may be communicatively coupled to the one or more processors. The cross-layer motion vector prediction logic module of a video coder may be communicatively coupled to the one or more processors and may be configured to determine a reference prediction motion vector in a reference layer of video data, and determine a target prediction motion vector in a target layer based at least in part on the reference prediction motion vector via cross-layer motion vector prediction, where the target layer is a higher layer than the reference layer.

In still other examples, a system may include an antenna, a video decoder, the like, and/or combinations thereof. The antenna may be configured to receive an encoded bitstream of video data. The video decoder may be communicatively coupled to the antenna and may be configured to decode the encoded bitstream. The video decoder may be configured to determine a reference prediction motion vector in a reference layer of video data, and determine a target prediction motion vector in a target layer based at least in part on the reference prediction motion vector via cross-layer motion vector prediction, where the target layer is a higher layer than the reference layer.

In a further example, at least one machine readable medium may include a plurality of instructions that in response to being executed on a computing device, causes the computing device to perform the method according to any one of the above examples.

In a still further example, an apparatus may include means for performing the methods according to any one of the above examples.

The above examples may include specific combination of features. However, such the above examples are not limited in this regard and, in various implementations, the above examples may include the undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

1-29. (canceled)

30. A computer-implemented method for video coding, comprising:
determining, via a video coder, a reference prediction motion vector in a reference layer of video data; and
determining, via the video coder, a target prediction motion vector in a target layer based at least in part on the reference prediction motion vector via cross-layer motion vector prediction, wherein the target layer is a higher layer than the reference layer.

31. The method of claim 30, wherein when the reference layer comprises a base layer, the target layer comprises an enhancement layer, and wherein when the reference layer comprises an enhancement layer, the target layer comprises a higher enhancement layer.

32. The method of claim 30, wherein the reference prediction motion vector may comprise a cross-layer spatial neighbor, a coded cross-layer earlier temporal neighbor in display order, or a coded cross-layer later temporal neighbor in display order.

33. The method of claim 30, further comprising:
determining, via the video coder, a further reference prediction motion vector for the reference layer of the video data.

34. The method of claim 30, further comprising:
determining, via the video coder, one or more further reference prediction motion vectors for the reference layer of the video data, and
wherein the determination, via the video coder, of the target prediction motion vector for the target layer is based at least in part on the one or more further reference prediction motion vectors and/or the reference prediction motion vector.

35. The method of claim 30, further comprising:
determining, via the video coder, one or more further reference prediction motion vectors for the reference layer of the video data,
wherein the determination, via the video coder, of the target prediction motion vector for the target layer is based at least in part on the one or more further reference prediction motion vectors and/or the reference prediction motion vector, and
wherein the one or more further reference prediction motion vectors and the reference prediction motion vector comprise two or more of a cross-layer spatial neighbor, a coded cross-layer earlier temporal neighbor in display order, and a coded cross-layer later temporal neighbor in display order.

36. The method of claim 30, further comprising:
determining, via the video coder, one or more further reference prediction motion vectors for the reference layer of the video data, wherein the one or more further reference prediction motion vectors and the reference prediction motion vector comprise two or more of a cross-layer spatial neighbor, a coded cross-layer earlier temporal neighbor in display order, and a coded cross-layer later temporal neighbor in display order,
wherein the determination, via the video coder, of the target prediction motion vector for the target layer is based at least in part on the one or more further reference prediction motion vectors and/or the reference prediction motion vector, and
wherein the one or more further reference prediction motion vectors and the reference prediction motion vector comprise scaled motion vectors.

37. The method of claim 30, further comprising:
determining, via the video coder, one or more further reference prediction motion vectors for the reference layer of the video data, wherein the one or more further reference prediction motion vectors and the reference prediction motion vector comprise two or more of a cross-layer spatial neighbor, a coded cross-layer earlier temporal neighbor in display order, and a coded cross-layer later temporal neighbor in display order;
determining, via the video coder, one or more in-layer reference prediction motion vectors for the target layer of the video data;
wherein the determination, via the video coder, of the target prediction motion vector for the target layer is based at least in part on the one or more further reference prediction motion vectors, the one or more in-layer reference prediction motion vectors, and/or the reference prediction motion vector, and
wherein the one or more in-layer reference prediction motion vectors comprise one or more of a coded in-layer spatial neighbor, a coded in-layer earlier temporal neighbor in display order, and a coded in-layer later temporal neighbor in display order.

38. The method of claim 30, further comprising:
determining, via the video coder, one or more further reference prediction motion vectors for the reference layer of the video data, wherein the one or more further reference prediction motion vectors and the reference prediction motion vector comprise two or more of a coded cross-layer spatial neighbor, a coded cross-layer earlier temporal neighbor in display order, and a coded cross-layer later temporal neighbor in display order;
determining, via the video coder, one or more in-layer reference prediction motion vectors for the target layer of the video data, wherein the one or more in-layer reference prediction motion vectors comprise one or more of a coded in-layer spatial neighbor, a coded in-layer earlier temporal neighbor in display order, and a coded in-layer later temporal neighbor in display order;
filtering, via the video coder, the one or more further reference prediction motion vectors, the one or more in-layer reference prediction motion vectors, and/or the reference prediction motion vector to form one or more filtered reference prediction motion vectors, wherein the filtering comprises one or more of the following operations: an averaging-type filter, a weighted averaging-type filter, a median-type filter; and
wherein the determination, via the video coder, of the target prediction motion vector for the target layer is based at least in part on the one or more filtered reference prediction motion vectors.

39. The method of claim 30, further comprising:
determining, via the video coder, one or more further reference prediction motion vectors for the reference layer of the video data, wherein the one or more further reference prediction motion vectors and the reference prediction motion vector comprise two or more of a coded cross-layer spatial neighbor, a coded cross-layer earlier temporal neighbor in display order, and a coded cross-layer later temporal neighbor in display order;
determining, via the video coder, one or more in-layer reference prediction motion vectors for the target layer of the video data, wherein the one or more in-layer reference prediction motion vectors comprise one or more of a coded in-layer spatial neighbor, a coded in-layer earlier temporal neighbor in display order, and a coded in-layer later temporal neighbor in display order;
selecting, via the video coder, an optimum reference prediction motion vector during coding based at least in part on a motion vector candidate list associated with two or more of the following motion vectors: the reference prediction motion vector, the one or more further reference prediction motion vectors, and the one or more in-layer reference prediction motion vectors; and
wherein the determination, via the video coder, of the target prediction motion vector for the target layer is based at least in part on the selected optimum reference prediction motion vector.

40. The method of claim 30, further comprising:
determining, via the video coder, one or more further reference prediction motion vectors for the reference layer of the video data, wherein the one or more further reference prediction motion vectors and the reference prediction motion vector comprise two or more of a cross-layer spatial neighbor, a coded cross-layer earlier temporal neighbor in display order, and a coded cross-layer later temporal neighbor in display order, wherein the one or more further reference prediction motion vectors and the reference prediction motion vector comprise scaled motion vectors,
wherein when the reference layer comprises a base layer, the target layer comprises an enhancement layer, and wherein when the reference layer comprises an enhancement layer, the target layer comprises a higher enhancement layer;
determining, via the video coder, one or more in-layer reference prediction motion vectors for the target layer of the video data, wherein the one or more in-layer reference prediction motion vectors comprise one or more of a coded in-layer spatial neighbor, a coded in-layer earlier temporal neighbor in display order, and a coded in-layer later temporal neighbor in display order;
filtering, via the video coder, the one or more further reference prediction motion vectors, the one or more in-layer reference prediction motion vectors, and/or the reference prediction motion vector to form one or more filtered reference prediction motion vectors, wherein the filtering comprises one or more of the following operations: an averaging-type filter, a weighted averaging-type filter, a median-type filter;
selecting, via the video coder, an optimum reference prediction motion vector during coding based at least in part on a motion vector candidate list associated with two or more of the following motion vectors: the reference prediction motion vector, the one or more further reference prediction motion vectors, the one or more in-layer reference prediction motion vectors, the scaled motion vectors, and the one or more filtered reference prediction motion vectors; and
wherein the determination, via the video coder, of the target prediction motion vector for the target layer is based at least in part on the selected optimum reference prediction motion vector.

41. A system for video coding on a computer, comprising:
a display device configured to present video data;
one or more processors communicatively coupled to the display device;
one or more memory stores communicatively coupled to the one or more processors;
a cross-layer prediction logic module of a video coder communicatively coupled to the one or more processors and configured to:
determine a reference prediction motion vector in a reference layer of video data, and
determine a target prediction motion vector in a target layer based at least in part on the reference prediction motion vector via cross-layer motion vector prediction, wherein the target layer is a higher layer than the reference layer.

42. The system of claim 41, wherein when the reference layer comprises a base layer, the target layer comprises an enhancement layer, and wherein when the reference layer comprises an enhancement layer, the target layer comprises a higher enhancement layer.

43. The system of claim 41, wherein the reference prediction motion vector may comprise a coded cross-layer spatial neighbor, a coded cross-layer earlier temporal neighbor in display order, or a coded cross-layer later temporal neighbor in display order.

44. The system of claim 41, wherein the cross-layer prediction logic is further configured to:
determine one or more further reference prediction motion vectors for the reference layer of the video data,
wherein the determination of the target prediction motion vector for the target layer is based at least in part on the one or more further reference prediction motion vectors and/or the reference prediction motion vector, and
wherein the one or more further reference prediction motion vectors and the reference prediction motion vector comprise two or more of a coded cross-layer spatial neighbor, a coded cross-layer earlier temporal neighbor in display order, and a coded cross-layer later temporal neighbor in display order.

45. The system of claim 41, wherein the cross-layer prediction logic is further configured to:
determine one or more further reference prediction motion vectors for the reference layer of the video data, wherein the one or more further reference prediction motion vectors and the reference prediction motion vector comprise two or more of a coded cross-layer spatial neighbor, a coded cross-layer earlier temporal neighbor in display order, and a coded cross-layer later temporal neighbor in display order,
wherein the determination of the target prediction motion vector for the target layer is based at least in part on the one or more further reference prediction motion vectors and/or the reference prediction motion vector, and
wherein the one or more further reference prediction motion vectors and the reference prediction motion vector comprise scaled motion vectors.

46. The system of claim 41, wherein the cross-layer prediction logic is further configured to:
determine one or more further reference prediction motion vectors for the reference layer of the video data, wherein the one or more further reference prediction motion vectors and the reference prediction motion vector comprise two or more of a coded cross-layer spatial neighbor, a coded cross-layer earlier temporal neighbor in display order, and a coded cross-layer later temporal neighbor in display order;
determine one or more in-layer reference prediction motion vectors for the target layer of the video data, wherein the one or more in-layer reference prediction motion vectors comprise one or more of a coded in-layer spatial neighbor, a coded in-layer earlier temporal neighbor in display order, and a coded in-layer later temporal neighbor in display order,
filter the one or more further reference prediction motion vectors, the one or more in-layer reference prediction motion vectors, and/or the reference prediction motion vector to form one or more filtered reference prediction motion vectors, wherein the filtering comprises one or more of the following operations: an averaging-type filter, a weighted averaging-type filter, a median-type filter; and
wherein the determination of the target prediction motion vector for the target layer is based at least in part on the one or more filtered reference prediction motion vectors.

47. The system of claim 41, wherein the cross-layer prediction logic is further configured to:
determine one or more further reference prediction motion vectors for the reference layer of the video data, wherein the one or more further reference prediction motion vectors and the reference prediction motion vector comprise two or more of a code cross-layer spatial neighbor, a code cross-layer earlier temporal neighbor in display order, and a coded cross-layer later temporal neighbor in display order;
determine one or more in-layer reference prediction motion vectors for the target layer of the video data, wherein the one or more in-layer reference prediction motion vectors comprise one or more of a coded in-layer spatial neighbor, a coded in-layer earlier temporal neighbor in display order, and a coded in-layer later temporal neighbor in display order,
select an optimum reference prediction motion vector during coding based at least in part on a motion vector candidate list associated with two or more of the following motion vectors: the reference prediction motion vector, the one or more further reference prediction motion vectors, and the one or more in-layer reference prediction motion vectors; and
wherein the determination of the target prediction motion vector for the target layer is based at least in part on the selected optimum reference prediction motion vector.

48. The system of claim 41, wherein the cross-layer prediction logic is further configured to:
determine one or more further reference prediction motion vectors for the reference layer of the video data, wherein the one or more further reference prediction motion vectors and the reference prediction motion vector comprise two or more of a coded cross-layer spatial neighbor, a coded cross-layer earlier temporal neighbor in display order, and a coded cross-layer later temporal neighbor in display order, wherein the one or more further reference prediction motion vectors and the reference prediction motion vector comprise scaled motion vectors,
wherein when the reference layer comprises a base layer, the target layer comprises an enhancement layer, and wherein when the reference layer comprises an enhancement layer, the target layer comprises a higher enhancement layer;
determine one or more in-layer reference prediction motion vectors for the target layer of the video data, wherein the one or more in-layer reference prediction motion vectors comprise one or more of a coded in-layer spatial neighbor, a coded in-layer earlier temporal neighbor in display order, and a coded in-layer later temporal neighbor in display order,
filter the one or more further reference prediction motion vectors, the one or more in-layer reference prediction motion vectors, and/or the reference prediction motion vector to form one or more filtered reference prediction motion vectors, wherein the filtering comprises one or more of the following operations: an averaging-type filter, a weighted averaging-type filter, a median-type filter;
select an optimum reference prediction motion vector during coding based at least in part on a motion vector candidate list associated with two or more of the following motion vectors: the reference prediction motion vector, the one or more further reference prediction motion vectors, the one or more in-layer reference prediction motion vectors, the scaled motion vectors, and the one or more filtered reference prediction motion vectors; and
wherein the determination of the target prediction motion vector for the target layer is based at least in part on the selected optimum reference prediction motion vector.

49. A system comprising:
an antenna configured to receive an encoded bitstream of video data; and
a video decoder communicatively coupled to the antenna and configured to decode the encoded bitstream, wherein the video decoder is configured to:
determine a reference prediction motion vector in a reference layer of video data, and
determine a target prediction motion vector in a target layer based at least in part on the reference prediction motion vector via cross-layer motion vector prediction, wherein the target layer is a higher layer than the reference layer.

50. The system of claim 49, wherein the video decoder is further configured to:
determine one or more further reference prediction motion vectors for the reference layer of the video data,
wherein the determination of the target prediction motion vector for the target layer is based at least in part on the one or more further reference prediction motion vectors and/or the reference prediction motion vector, and
wherein the one or more further reference prediction motion vectors and the reference prediction motion vector comprise two or more of a coded cross-layer spatial neighbor, a coded cross-layer earlier temporal neighbor in display order, and a coded cross-layer later temporal neighbor in display order.

51. The system of claim 49, wherein the video decoder is further configured to:
determine one or more further reference prediction motion vectors for the reference layer of the video data, wherein the one or more further reference prediction motion vectors and the reference prediction motion vector comprise two or more of a coded cross-layer spatial neighbor, a coded cross-layer earlier temporal neighbor in display order, and a coded cross-layer later temporal neighbor in display order,
wherein the determination of the target prediction motion vector for the target layer is based at least in part on the one or more further reference prediction motion vectors and/or the reference prediction motion vector, and
wherein the one or more further reference prediction motion vectors and the reference prediction motion vector comprise scaled motion vectors.

52. The system of claim 49, wherein the video decoder is further configured to:
determine one or more further reference prediction motion vectors for the reference layer of the video data, wherein the one or more further reference prediction motion vectors and the reference prediction motion vector comprise two or more of a coded cross-layer spatial neighbor, a coded cross-layer earlier temporal neighbor in display order, and a coded cross-layer later temporal neighbor in display order;
determine one or more in-layer reference prediction motion vectors for the target layer of the video data, wherein the one or more in-layer reference prediction motion vectors comprise one or more of a coded in-layer spatial neighbor, a coded in-layer earlier temporal neighbor in display order, and a coded in-layer later temporal neighbor in display order,
filter the one or more further reference prediction motion vectors, the one or more in-layer reference prediction motion vectors, and/or the reference prediction motion vector to form one or more filtered reference prediction motion vectors, wherein the filtering comprises one or more of the following operations: an averaging-type filter, a weighted averaging-type filter, a median-type filter; and
wherein the determination of the target prediction motion vector for the target layer is based at least in part on the one or more filtered reference prediction motion vectors.

53. The system of claim 49, wherein the video decoder is further configured to:
determine one or more further reference prediction motion vectors for the reference layer of the video data, wherein the one or more further reference prediction motion vectors and the reference prediction motion vector comprise two or more of a coded cross-layer spatial neighbor, a coded cross-layer earlier temporal neighbor in display order, and a coded cross-layer later temporal neighbor in display order;
determine one or more in-layer reference prediction motion vectors for the target layer of the video data, wherein the one or more in-layer reference prediction motion vectors comprise one or more of a coded in-layer spatial neighbor, a coded in-layer earlier temporal neighbor in display order, and a coded in-layer later temporal neighbor in display order,
select an optimum reference prediction motion vector during coding based at least in part on a motion vector candidate list associated with two or more of the following motion vectors: the reference prediction motion vector, the one or more further reference prediction motion vectors, and the one or more in-layer reference prediction motion vectors; and
wherein the determination of the target prediction motion vector for the target layer is based at least in part on the selected optimum reference prediction motion vector.

54. The system of claim 49, wherein the video decoder is further configured to:
determine one or more further reference prediction motion vectors for the reference layer of the video data, wherein the one or more further reference prediction motion vectors and the reference prediction motion vector comprise two or more of a coded cross-layer spatial neighbor, a coded cross-layer earlier temporal neighbor in display order, and a coded cross-layer later temporal neighbor in display order, wherein the one or more further reference prediction motion vectors and the reference prediction motion vector comprise scaled motion vectors,
wherein when the reference layer comprises a base layer, the target layer comprises an enhancement layer, and wherein when the reference layer comprises an enhancement layer, the target layer comprises a higher enhancement layer;
determine one or more in-layer reference prediction motion vectors for the target layer of the video data, wherein the one or more in-layer reference prediction motion vectors comprise one or more of a coded in-layer spatial neighbor, a coded in-layer earlier temporal neighbor in display order, and a coded in-layer later temporal neighbor in display order,
filter the one or more further reference prediction motion vectors, the one or more in-layer reference prediction motion vectors, and/or the reference prediction motion vector to form one or more filtered reference prediction motion vectors, wherein the filtering comprises one or more of the following operations: an averaging-type filter, a weighted averaging-type filter, a median-type filter;
select an optimum reference prediction motion vector during coding based at least in part on a motion vector candidate list associated with two or more of the following motion vectors: the reference prediction motion vector, the one or more further reference prediction motion vectors, the one or more in-layer reference prediction motion vectors, the scaled motion vectors, and the one or more filtered reference prediction motion vectors; and
wherein the determination of the target prediction motion vector for the target layer is based at least in part on the selected optimum reference prediction motion vector.
